(19) United States
(12) Patent Application Publication
(10) Pub. No.: US 2002/0153939 A1
(43) Pub. Date: Oct. 24, 2002

(54) BOOSTING CIRCUIT WITH HIGH VOLTAGE GENERATED AT HIGH SPEED

(76) Inventor: MASAYOSHI HIRATA, TOKYO (JP)

Correspondence Address: MCGINN & GIBB, PLLC, 8321 OLD COURTHOUSE ROAD, SUITE 200, VIENNA, VA, 22182-3817, US

(21) Appl. No.: 09/325,730

(22) Filed: Jun. 4, 1999

(30) Foreign Application Priority Data
Jun. 15, 1998 (JP) 166726/1998

(51) Int. Cl. G05F 3/02

(52) U.S. Cl. 327/536

(57) ABSTRACT

A boosting circuit for supplying a boosted voltage to an external capacitor, includes a plurality of capacitors, a charging section and a connection control section. The charging section charges each of the plurality of capacitors to a power supply voltage in a charging mode. The connection control section connects, in the boosting mode, the plurality of capacitors in series while a first one of the plurality of charged capacitors is biased by the power supply voltage such that the external capacitor is charged by the plurality of capacitors connected in series.

### BACKGROUND OF THE INVENTION

1. Field of the Invention

The present invention relates to a boosting circuit, and more particularly to a boosting circuit for generating a voltage higher than a power supply voltage.

2. Description of the Related Art

As a circuit used in a conventional semiconductor memory device such as a flash memory device, a boosting circuit and a charge pump circuit are known. Especially, the boosting circuit is widely used as a voltage supply circuit for a word line selected in the memory device.

FIG. 1 is a block diagram illustrating a conventional boosting circuit. Referring to FIG. 1, the conventional boosting circuit is a primary boosting section 1 and a boosted capacitor C2. The primary boosting section 1 is composed of an inverter IV11, a diode DC11, a boost capacitor C11. The inverter IV11 inverts a clock signal CK to output a drive signal CKB. The diode D11 has an anode connected with a power supply voltage VCC and a cathode connected to the boost capacitor C11. The boost capacitor C11 is supplied with the drive signal CKB at one end and receives the supply of electric charge from the power supply VCC through the diode D11 and outputs a boosting voltage VCP. The capacitor C2 is composed of a parasitic capacitor, which is connected to the ground potential level at one end and to the boost capacitor C11 at the other end.

FIGS. 2A to 2C are time charts illustrating waveforms at the respective sections of the boosting circuit. Referring to FIG. 1 and FIG. 2, the operation of the conventional boosting circuit will be described.

First, the electric charge is stored in the boost capacitor C11 of the primary boosting section 1 in a charging mode. More particularly, the clock signal CK of a H (high) level is inputted to the inverter IV11. At this time, the inverter IV11 sets the drive signal CKB to the L (low) level in response to the clock signal CK of the H level. The diode D11 stores in the boost capacitor C11 the electric charge corresponding to the voltage vcc of the power supply VCC. Thus, a voltage value vcp of the boost voltage VCP rises to the power supply voltage vcc (State S1).

Next, when an operation mode is switched to a boosting mode, the clock signal CK is set to the L level so that the inverter IV11 sets the drive signal CKB to the H level of the power supply voltage vcc in response to the clock signal CK of the L level. Thus, the boost voltage VCP is increased to a voltage vcp (State S2).

In thid case, the voltage value vcp of the boost voltage VCP is computed as follows.

vcp={(2×2c1+c2)×vcc}/(c1+c2)

where c1 and c2 are capacitor values of the capacities C11 and C2, respectively. That is, the voltage value vcp of the boost voltage VCP never goes out from the range of vcc <vcp<2vcc. In this way, in the semiconductor memory device provided with the above-mentioned conventional boosting circuit, the boosted voltage is equal to or less than twice of the power supply voltage.

By the way, because the power supply voltage VCC is decreased in conjunction with a large capacitor and a fine pattern formation of the semiconductor memory device, the boosted voltage value vcp is necessarily decreased, too. However, in the semiconductor memory devices such as a flash memory, the voltage required to access the word line is not decreased. Therefore, the adaptation of the boosting circuit becomes difficult.

In conjunction with the above, a non-volatile semiconductor memory device is disclosed in Japanese Laid Open Patent Application (JP-A-Heisei 1-134796). In this reference, the non-volatile semiconductor memory device is composed of a high voltage generating circuit and a boosting circuit. The high voltage generating circuit is composed of a diode-connected MOS transistor and a capacitor. The boosting circuit is composed of a high voltage switch for boosting a word line and a bit line based on the output of the high voltage generating circuit. The phase of a clock signal applied to the high voltage switch is opposite to that of the clock signal applied to the last stage of the high voltage generating circuit.

A non-volatile semiconductor memory is disclosed in Japanese Laid Open Patent Application (JP-A-Heisei 6-223588). In this reference, a plurality of basic circuits 20 for executing a boosting operation are grouped into a plurality of groups. Clock signals φ1 and φ2 are supplied to a part of the plurality of groups immediately after the boosting operation is started. The clock signals φ1 and φ2 are supplied to another part of the plurality of groups after a predetermined time from the start of the boosting operation. The clock signals φ1 and φ2 are supplied to the remaining part of the plurality of groups after a further predetermined time from the start of the boosting operation.

Also, an SRAM memory backup circuit is disclosed in Japanese Laid Open Patent Application (JP-A-Heisei 4-192191). In this reference, a capacitor is charged using an internal clock generating circuit. Therefore, even when an external power supply is disconnected, the charge of the capacitor is supplied such that a memory cell data can be held.

### SUMMARY OF THE INVENTION

Therefore, an object of the present invention is to provide a boosting circuit which can generate a desired boosted voltage in a high efficiency.

Another object of the present invention is to provide a semiconductor memory device including such a boosting circuit.

In order to achieve an aspect of the present invention, a boosting circuit for supplying a boosted voltage to an external capacitor, includes a plurality of capacitors, a charging section and a connection control section. The charging section charges each of the plurality of capacitors to a power supply voltage in a charging mode. The connection control section connects, in the boosting mode, the plurality of capacitors in series while a first one of the plurality of charged capacitors is biased by the power supply voltage such that the external capacitor is charged by the plurality of capacitors connected in series.

The charging mode and the boosting mode are set in first and second halves of every period of a clock signal such that the boosted voltage is applied to the external capacitor for every period of the clock signal.

The charging section may include a plurality of charging circuits provided for the plurality of capacitors, respectively. In this case, each of the plurality of charging circuits may include a diode connected between the power supply voltage and a corresponding one of the plurality of capacitors. Instead, each of the plurality of charging circuits may charge a corresponding one of the plurality of capacitors in response to a charge control signal. The charge control signal may be common to the plurality of charging circuits.

The connection control section may include a first circuit for the first capacitor, and a group of second circuits for the plurality of capacitors other than the first capacitor. In this case, the first circuit may include an inverter circuit connecting the first capacitor to the ground potential level in the charging mode, and biasing the first capacitor by the power supply voltage in the boosting mode. Also, each of the second circuits may include a switch connecting the plurality of capacitors other than the first capacitor to the ground potential level in the charging mode and connecting the plurality of capacitors in series in the boosting mode. In this case, the switch may include first and second switching elements. The first switching element connects one end of the corresponding capacitor to the ground potential level in the charging mode, the capacitor being disconnected from the ground potential level in the boosting mode in response to a first control signal. Also, the second switching element connects the one end of the corresponding capacitor to the other end of the capacitor of the first or second circuit at a previous stage in the boosting mode in response to a second control signal. The first and second control signals are generated in the first and second halves of every period of the clock signal, respectively.

In order to achieve another aspect of the present invention, a method of supplying a boosted voltage to an external capacitor, includes:

alternately setting a charging mode and a boosting mode for every period of a clock signal;

charging each of a plurality of capacitors to a power supply voltage in the charging mode; and

connecting the plurality of capacitors in series in the boosting mode such that the boosted voltage is supplied to the external capacitor.

The charging may be performed by charging each of the plurality of capacitors through a diode. Instead, the charging may be performed by charging each of the plurality of capacitors in response to a charge control signal.

Also, the charging may be performed by charging a first one of the plurality of capacitors in response to a first half of every period of the clock signal, the first half corresponding to the charging mode. Also, the boosting may be performed by biasing the first capacitor by the power supply voltage in response to a second half of every period of the clock signal, the second half corresponding to the boosting mode, and by connecting the plurality of capacitors in series in response to the second half of every period of the clock signal. In this case, the method may further includes generating a first control signal during the first half of every period of the clock signal, and generating a second control signal during the second half of every period of the clock signal. The charging may be performed by connecting the plurality of capacitors to a ground potential level in response to the first control signal, and the boosting may be performed by connecting the plurality of capacitors in series in response to the second control signal.

In order to achieve still another aspect of the present invention, a boosting circuit for supplying a boosted voltage to an external capacitor, includes a primary boosting section including a first capacitor, wherein the primary boosting section charges the first capacitor to a power supply voltage in a charging mode, and biases the first capacitor by the power supply voltage in a boosting mode, and a plurality of secondary boosting sections, each of which includes a second capacitor, wherein each of the plurality of secondary boosting sections connects one end of the second capacitor to the ground potential level in the charging mode and connects the one end of the second capacitor to the other end of the second capacitor of the secondary boosting section of a previous stage in the boosting mode.

### BRIEF DESCRIPTION OF THE DRAWINGS

FIG. 1 is a block diagram illustrating an example of a conventional boosting circuit;

FIGS. 2A to 2C are time charts illustrating the operation of the conventional boosting circuit;

FIG. 3 is a block diagram illustrating the structure of a conceptual boosting circuit of the present invention;

FIGS. 4A to 4E are time charts illustrating the operation of the conceptual boosting circuit of the present invention;

FIG. 5 is a circuit diagram illustrating the structure of the boosting circuit according to a first embodiment of this embodiment;

FIG. 6 is a characteristic diagram illustrating a simulation of the operation of the boosting circuit according to the first embodiment of the present invention; and

FIG. 7 is a block diagram illustrating the structure of the boosting circuit according to the second embodiment of this embodiment.

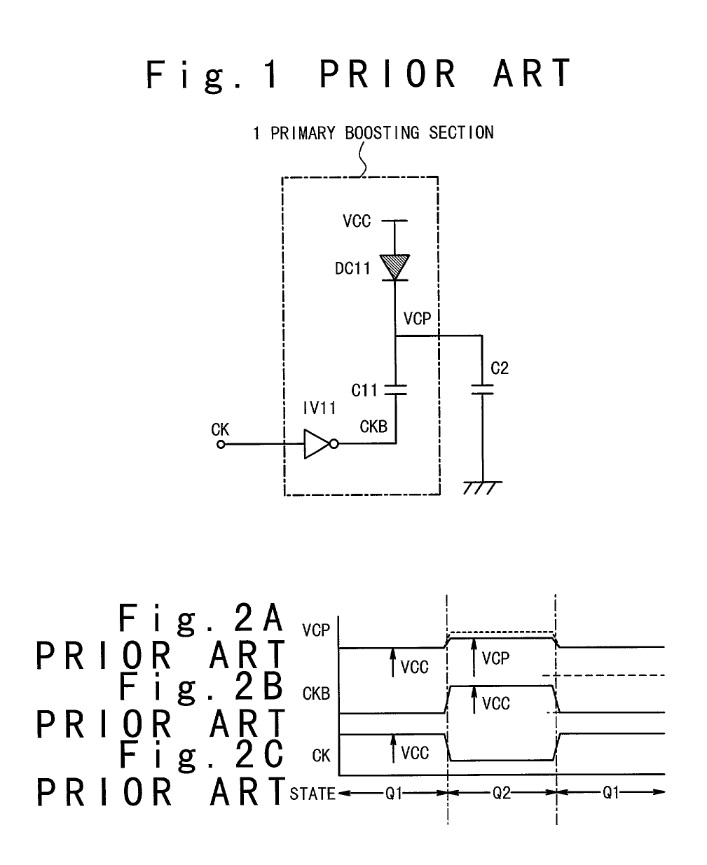

### DETAILED DESCRIPTION OF THE PREFERRED EMBODIMENTS

Next, a boosting circuit of the present invention will be described below in detail with reference to the attached drawings.

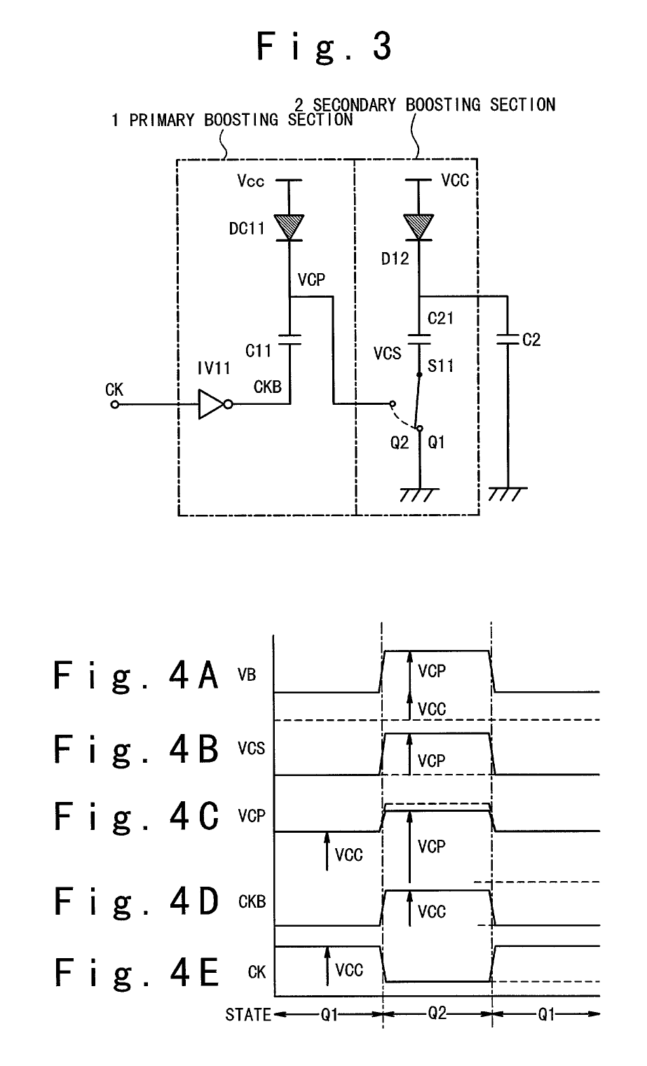

FIG. 3 is a block diagram illustrating a basic concept of the boosting circuit of the present invention. Referring to FIG. 3, the boosting circuit is composed of a primary boosting section 1 and a secondary boost section 2.

The primary boosting section 1 is composed of an inverter IV11, a diode D11, and a boost capacitor C11. The inverter IV11 inverts a clock signal CK to output a drive signal CKB. The diode D11 has a anode connected with a power supply VCC and the cathode connected with one end of the boost capacitor C11. The boost capacitor C11 is charged through the diode DC11 from the power supply VCC. Also, the boost capacitor C11 receives the supply of the drive signal CKB at the other end from the inverter IV11 to output a boosting voltage VCP.

The secondary boost section 2 is composed of a boost capacitor C21, a diode D21, and a switch 21. The diode D21 has an anode connected with the power supply VCC and a cathode connected with the boost capacitor C21. The boost capacitor C21 has one end connected with the cathode of diode D11 and the other end connected with a common node of the switch S11. A parasitic capacitor C2 is connected with the boost capacitor C21 at one end. The parasitic capacitor C2 is connected to the ground potential level at other end. The switch 21 is connected with the other end of the boost capacitor C21 at the common node. One of switching nodes of the switch S11 is connected to the boost capacitor C11 and the other switching node is connected with the ground potential potential. In the boosting mode, the capacitors C11 and C12 are connected in series by the switch S11.

Next, FIGS. 4A to 4E are time charts illustrating the waveforms of the respective sections of the boosting circuit shown in FIG. 3. Referring to FIGS. 4A to 4E, the operation of the boosting circuit of the present invention will be described.

First, in a charging mode, the input clock signal CK is has a H level of the voltage vcc. By this, the inverter IV11 sets the drive signal CKB to the L level in response to the clock signal CK of the H level. At this time, one end of the boost capacitor C21 is connected to the ground potential level by the switch S21 in the secondary boost section 2 such that a voltage VCS of the one end of the boost capacitor C21 is set to the ground potential level. Then, the electric charges are stored in the boost capacitor C11 in the primary boosting section 1 and the boost capacitor C21 in the secondary boost section 2 through the diodes D11 and D21 from the power supply VCC, respectively. Thus, the respective output voltages VCP and VCS of the capacitors C11 and C21 are set to the voltage vcc of the power supply VCC (State Q1).

Next, when the operation mode is switched to a boosting mode, the input clock signal CK changes the level from the H level into the L level. Thus, the inverter IV11 sets the drive signal CKB to the H level of vcc) in response to the clock signal CK of the L level. Also, the one end of the boost capacitor C21 is separated from the ground potential level by the switch S21 and is connected with the other end of the boost capacitor C11. That is, a connection of the switch S11 is changed for capacitors C11 and C21 to be connected in series. Therefore, the output voltage VCP of the boost capacitor C11 is raised to a predetermined boost voltage VCP (vcc<vcp<2vcc). Thus, the output voltage VCP of the boost capacitor C21, i.e., the voltage value vb of the output boost voltage VB is boosted to the voltage of vcc+vcp (State S2).

Through the above operation, the parasitic capacitor C2 can receive the supply of the high voltage.

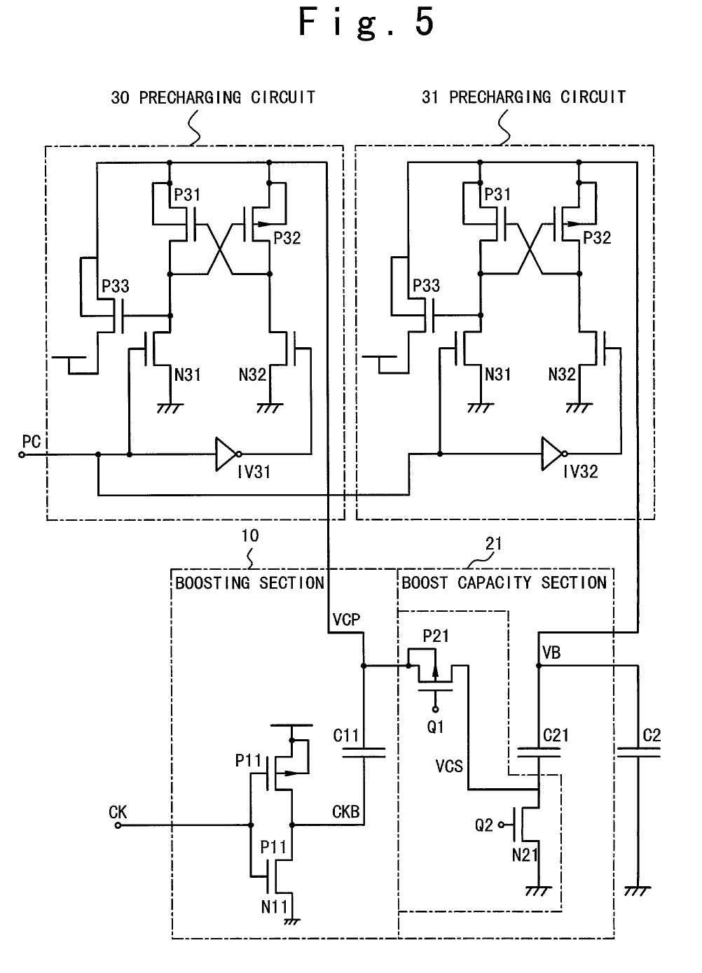

Next, the boosting circuit according to the first embodiment of the present invention will be described below. FIG. 5 shows the structure of the boosting circuit according to the first embodiment of the present invention.

Referring to FIG. 5, the boosting circuit is composed of the primary boosting section 10 and the secondary boost section 20. The primary boosting section 1 is composed of a precharging circuit 30 and a boosting section 10. The secondary boosting section 2 is composed of a precharging circuit 31 and a boost capacity section 21.

In the primary boosting section 1 and the secondary boost section 2, the diodes D11 and D21 shown in FIG. 3 are removed. In the boosting circuit in the first embodiment, the precharging circuits 30 and 31 are provided to store the electric charges in the capacitors C11 and C21 in response to a precharge signal PC, in place of the diodes D11 and D21.

The boosting section 10 is provided with the inverter IV11 and a boost capacitor C11. The inverter IV11 outputs the drive signal CKB in response to the supply of the clock signal CK. The inverter IV11 is composed of a P-channel enhancement type transistor P11 and an N-channel enhancement type transistor N11. The P-channel enhancement type transistor P11 has the source connected with the power supply VCC, the gate receiving the clock signal CK, and the drain. The N-channel enhancement type transistor N11 has the drain connected with the drain of the transistor P11, the gate connected with the gate of the transistor P11 and the source connected with the ground potential level. A common connection node of the drains of the transistors P11 and N11 functions as the output node.

The boost capacity section 21 is composed of a boost capacitor C21 and a switch S21 connecting one end of the boost capacitor C21 to the ground potential level or the one end of the boost capacitor C11 in response to the supply of a state signal Q1 or Q2. The switch S21 is composed of a P-channel enhancement type transistor P21 and an N-channel enhancement type transistor N21. The P-channel enhancement type transistor P21 has the gate receiving a switch signal Q1, the source connected with the output node of the boost capacitor C11 in the boosting section 10 and the drain connected with the input node of the boost capacitor C21 in the boost capacity section 21. The N-channel enhancement type transistor N21 has the gate receiving a switch signal Q2, the drain connected with the input node of the boost capacitor C21 and the source connected with the ground potential level.

The precharging sections 30 and 31 have the same circuit structure. For example, the precharging section 30 is composed of an inverter IV31, an N-channel enhancement type transistor N31, an N-channel enhancement type transistor N32, a P-channel enhancement type transistor P31, a P-channel enhancement type transistor P32, and a P-channel enhancement type transistor P33. The inverter IV31 inverts a precharge signal PC to output an inverted precharge signal PCB. The N-channel enhancement type transistor N31 has the source connected with the ground potential level and the gate receiving the precharge signal PC. The N-channel enhancement type transistor N32 has the source connected with the ground potential level and the gate receiving the inverted precharge signal PCB. The P-channel enhancement type transistor P31 has the gate connected with the drain of the transistor N31 and the drain connected with the drain of the transistor N32 and the source outputting an output signal VCP. The P-channel enhancement type transistor P32 has the source connected with the source of the transistor P31, the drain connected with the drain of the transistor N32 and the gate connected with the drain of the transistor N31. The P-channel enhancement type transistor P33 has the gate connected with the drain of the transistor N31, the drain connected with the source of the transistor P31, the source connected with power supply VCC and a well connected with the drain. Moreover, the drain of the transistor P33 is connected with the output node of the boost capacitor C11 of the boosting section 10 to supply the power supply VCC at the time of the H level of the precharge signal PC.

In the same way, the drain of the transistor P33 of the precharge section 31 is connected with the output node of the boost capacitor C21 in the boost capacitor 21 to supply the power supply VCC at the time of the H level of the precharge signal PC.

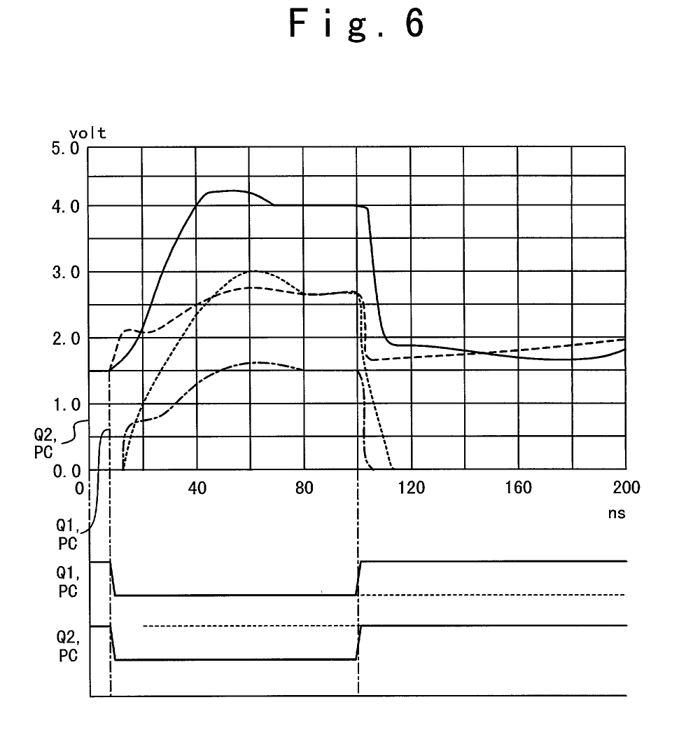

Next, the operation of the first embodiment will be described with reference to FIG. 5 and FIG. 6 illustrating the waveforms of the respective sections.

First, in the charging mode, the clock signal CK, the switch signals Q1 and Q2 and the precharge signal PC are in the H level. Also, the inverter IV11 sets the drive signal CKB to the L level in response to clock signal CK of the H level. The transistor N21 is set to the conductive state in response to the switch signal Q2 of the H level to set the input node of the boost capacitor C21 to the ground potential level. Also, the transistor P21 on the input side of the boost capacitor C21 is blocked off in response to the switch signal Q1 of the H level. The precharging circuits 30 and 31 charge the boost capacitor C11 and C21 to the power supply voltage vcc in response to the precharge signal PC of the H level to generate corresponding output voltages VCP and VB (State Q1).

The operation of the precharging circuit 30 will be described. The transistors N31, N32, P31, and P32 operates as a level shifter circuit. The drain of the transistor N31 of the level shifter circuit outputs the L level in response to the precharge signal PC of the H level. The transistor P33 is set to the conductive state in response to the L level of the drain of the transistor N31 which is applied to the gate of the transistor P33. As a result, the power supply VCC is supplied to the boost capacitor C11 such that the output boost voltage VCP of the boost capacitor C11 is charged to the power supply voltage vcc. In the same way, the precharging circuit 32 supplies the power supply VCC to the boost capacitor C21 in response to the precharge signal PC of the H level such that the output boost voltage VB of the boost capacitor C21 is charged to the voltage vcc.

Next, when the operation mode is switched to the boosting mode, the input clock signal CK, the switch signals Q1 and Q2 and the respective precharge signals PC are switched from the H level into the L level. The transistor N21 is turned off in response to the switch signal Q2 of the L level. The transistor P21 on the input side of the boost capacitor C21 is set to the conductive state in response to the switch signal Q1 of the L level so that the boost capacitor C11 and the boost capacitor C21 are connected in series.

The inverter IV11 sets the drive signal CKB to the H level of the power supply voltage vcc level in response to the input clock signal CK of the L level. At the same time, in the precharging circuits 30 and 31, the drain of the transistor N31 of the level shifter circuit is set to the H level in response to the precharge signal PC of the L level. As a result, the transistor P33 is turned off and blocks off the supply of the electric charge to the boost capacitors C11 and C21.

The operation of the boost state will be described in detail with reference to FIG. 6. First, the precharge signal PC and the switch signal Q2 are changed into the L level (T=0). In response to the change of the precharge signal PC to the L level, the output of each level shifter circuit of the precharging circuits 30 and 31 is changed into the H level. As a result, the transistor P33 is set to the non-conductive state to block off the supply of the electric charge from the power supply VCC. The transistor N21 is turned off in response to the switch signal Q2 of the L level so that the input node of the boost capacitor C21 becomes a floating state.

Next, the clock signal CK and the switch signal Q1 externally supplied are switched to to the L level (T=10 ns). The transistor P21 on the input side of the boost capacitor C21 is set to the conductive state in response to the switching of the switch signal Q1 to the L level. As a result, the boost voltage VCP of the output of the boost capacitor C11 and the voltage VCS of the input node of the boost capacitor C21 become the same voltage. At this moment, the potential difference between the drive signal CKB and the output boost voltage VB becomes twice the power supply voltage. Actually, the electric charge which has been accumulated in the boost capacitor C21 is moved to the capacitor C2 in accordance with the ratio of the capacitor C2 and the boost capacitor C21 to increase the output boost voltage VB to a predetermined voltage.

Through the above operation, the output boost voltage VB becomes possible to perform the boosting operation using the high voltage at the moment. Thus, in the present invention, the boosting voltage level and the boosting speed can be attained. This cannot be attained in the conventional boosting circuit.

Referring to FIG. 6 once again, it is supposed that the boost capacitors C11 and C21 have the capacity of 100 pF and the capacitor C2 has the capacity of 10 pF. As illustrated, the boost capacitors C11 and C21 are connected in series at the time of T=10 ns and the output boost voltage VB is boosted quickly.

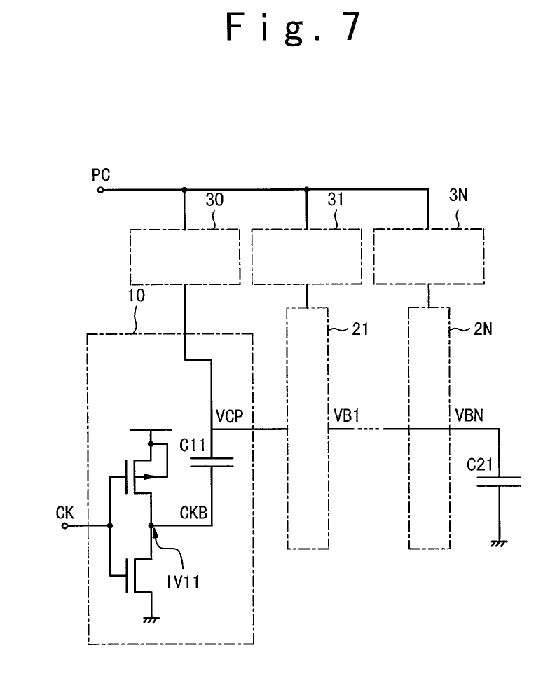

Next, FIG. 7 is a block diagram illustrating the structure of the boosting circuit according to the second embodiment of the present invention. Referring to FIG. 7, the boosting circuit in the second embodiment is different from the boosting circuit the first embodiment in the following points. That is, N (N is an integer equal to or more than 2) boost capacitor sections 21, 22, ••• 2N including the boost capacitor section 21 are connected in series. Also, N precharging circuits 31, 32, 3N are provided for the N boost capacitor sections, respectively.

The operation of each boost capacitor section is the same as that of the boost capacitor section in the first embodiment. Therefore, the boost voltage of each stage becomes VB1, VB2, ••• VBN, and a theoretical output boost voltage VBN of the last stage becomes a voltage obtained by multiplying the power supply voltage with (1+ number of stages connected in series). Thus, the boosted voltage for one period of the clock signal can be further increased.

As described above, according to the present invention, a plurality of boost capacitors are charged in parallel in the charging mode and connected in series in the boosting mode. Therefore, a higher boosted voltage can be generated quickly. Thus, the high boosted voltage can be attained for every period of the clock signal.

What is claimed is:

1. A boosting circuit for supplying a boosted voltage to an external capacitor, comprising:
a plurality of capacitors;
a charging section charging each of said plurality of capacitors to a power supply voltage in a charging mode; and
a connection control section connecting, in said boosting mode, said plurality of capacitors in series while a first one of said plurality of charged capacitors is biased by said power supply voltage such that said external capacitor is charged by said plurality of capacitors connected in series.

2. A boosting circuit according to claim 1, wherein said charging mode and said boosting mode are set in first and second halves of every period of a clock signal such that said boosted voltage is applied to said external capacitor for every period of said clock signal.

3. A boosting circuit according to claim 1, wherein said charging section includes a plurality of charging circuits provided for said plurality of capacitors, respectively.

4. A boosting circuit according to claim 3, wherein each of said plurality of charging circuits includes a diode connected between said power supply voltage and a corresponding one of said plurality of capacitors.

5. A boosting circuit according to claim 3, wherein each of said plurality of charging circuits charges a corresponding one of said plurality of capacitors in response to a charge control signal.

6. A boosting circuit according to claim 5, wherein said charge control signal is common to said plurality of charging circuits.

7. A boosting circuit according to claim 1, wherein said connection control section includes:
a first circuit for said first capacitor; and
a group of second circuits for said plurality of capacitors other than said first capacitor, and
wherein said first circuit includes an inverter circuit connecting said first capacitor to said ground potential level in said charging mode, and biasing said first capacitor by said power supply voltage in said boosting mode, and
wherein each of said second circuits includes a switch connecting said plurality of capacitors other than said first capacitor to said ground potential level in said charging mode and connecting said plurality of capacitors in series in said boosting mode.

8. A boosting circuit according to claim 7, wherein said switch includes first and second switching elements,
wherein said first switching element connects one end of said corresponding capacitor to said ground potential level in the charging mode, said capacitor being disconnected from said ground potential level in said boosting mode in response to a first control signal, and
wherein said second switching element connects said one end of said corresponding capacitor to the other end of said capacitor of said first or second circuit at a previous stage in said boosting mode in response to a second control signal.

9. A boosting circuit according to claim 8, wherein said first and second control signals are generated in said first and second halves of every period of said clock signal, respectively.

10. A method of supplying a boosted voltage to an external capacitor, comprising:
alternately setting a charging mode and a boosting mode for every period of a clock signal;
charging each of a plurality of capacitors to a power supply voltage in said charging mode; and
connecting said plurality of capacitors in series in said boosting mode such that said boosted voltage is supplied to said external capacitor.

11. A method according to claim 10, wherein said charging includes charging each of said plurality of capacitors through a diode.

12. A method according to claim 10, wherein said charging includes charging each of said plurality of capacitors in response to a charge control signal.

13. A method according to claim 10, wherein said charging includes charging a first one of said plurality of capacitors in response to a first half of every period of said clock signal, said first half corresponding to said charging mode, and
wherein said boosting includes:
biasing said first capacitor by said power supply voltage in response to a second half of every period of said clock signal, said second half corresponding to said boosting mode; and
connecting said plurality of capacitors in series in response to said second half of every period of said clock signal.

14. A method according to claim 13, further comprising:
generating a first control signal during said first half of every period of said clock signal; and
generating a second control signal during said second half of every period of said clock signal,
wherein said charging includes connecting said plurality of capacitors to a ground potential level in response to said first control signal, and
wherein said boosting includes connecting said plurality of capacitors in series in response to said second control signal.

15. A boosting circuit for supplying a boosted voltage to an external capacitor, comprising:
a primary boosting section including a first capacitor, wherein said primary boosting section charges said first capacitor to a power supply voltage in a charging mode, and biases said first capacitor by said power supply voltage in a boosting mode; and
a plurality of secondary boosting sections, each of said plurality of secondary boosting sections connects one end of said second capacitor to said ground potential level in said charging mode and connects said one end of said second capacitor to the other end of said second capacitor of said secondary boosting section of a previous stage in said boosting mode.
